(19) United States
(12) Patent Application Publication
(10) Pub. No.: US 2008/0174777 A1
(43) Pub. Date: Jul. 24, 2008

(54) Spectrometers using 2-dimensional microelectromechanical digital micromirror devices

(75) Inventor: Keith Carron, Centennial, WY (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(73) Assignee: University of Wyoming, Laramie, WY (US)

(21) Appl. No.: 11/786,234

(22) Filed: Apr. 11, 2007

Related U.S. Application Data
(60) Provisional application No. 60/791,174, filed on Apr. 11, 2006.

(51) Int. Cl. G01J 3/28; G01J 3/00; G01N 21/47

(52) U.S. Cl. 356/328; 356/300; 356/446

(57) ABSTRACT

Echelle gratings and microelectromechanical system (MEMS) digital micromirror device (DMD) detectors are used to provide rapid, small, and highly sensitive spectrometers. The new spectrometers are particularly useful for laser induced breakdown and Raman spectroscopy, but could generally be used with any form of emission spectroscopy. The new spectrometers have particular applicability in the detection of improvised explosive devices.

This application claims priority to U.S. Patent Application Ser. No. 60/791,174 filed Apr. 11, 2006.

### BACKGROUND OF THE INVENTION

The invention relates generally to spectrometers and, more specifically, to the use of digital micromirror devices in spectrometers that use echelle gratings.

Spectrometers are in wide use in both research and industry, particularly in the detection and analysis of a variety of materials. An emerging area of spectroscopy is laser-induced breakdown spectroscopy or LIBS. LIBS uses a laser beam to create a high-temperature plasma out of a very small amount (as little as picograms) of a sample. The sample may be solid, liquid or gas and little or no preparation of the sample is typically required. In an existing LIBS spectrometer sold by Ocean Optics Inc., seven fiber optics cables, seven echelle gratings, and seven charge-coupled device (CCD) detectors are used to obtain the required high resolution and large spectral range. A disadvantage of the Ocean Optics device is that a major portion of the light from the vaporized sample to be analyzed by the instrument is lost in the seven cables and gratings.

Another use of echelle gratings is in spectrometers used for Raman spectroscopy. InPhotocics Inc. sells an instrument that uses a 2-dimensional CCD chip to acquire high resolution Raman spectra with a small footprint. A disadvantage of CCD chips is their high cost and the time required to read to read the whole chip.

The Thermo Jarrell Ash Corporation sells ICP (induction-coupled plasma) spectrometers that use echelle gratings and 2-dimensional detector called a CID (charge injection device). A CID detector has the advantage over a CCD detector in that the individual pixels of the CID can be read-out without reading the whole chip. This saves time and allows an instrument to selectively interrogate one pixel or one atomic species. Another advantage promoted for the CID-based instrument is that strong peaks in the spectrum can be read rapidly and weaker peaks can be read after longer integration times.

### SUMMARY OF THE INVENTION

The invention consists of a spectrometer that uses a microelectromechanical (MEM) digital micromirror device (DMD) array to reduce the cost and speed up the time required for analysis. In a preferred embodiment, light to be analyzed is directed onto an echelle grating. The dispersed light passes through a prism that acts as an order separator. The light then is focused on the MEM DMD array. The individual mirrors on the MEM DMD array are adjusted to correspond to a spectrogram that is characteristic of a substance that is to be detected by the spectrometer and to direct such light to a detector. In a preferred embodiment, a single channel detector is used.

Spectrometers of the present invention have relatively simple optics and will pass a large percentage of the incident signal light to the detector. Because no charge-coupled device detector is required, there is no time delay associated with reading of the chip. Further, the simplicity of the optics and the elimination of charge-coupled devices reduces the cost of the spectrometers of the present invention.

### BRIEF DESCRIPTION OF THE DRAWINGS

FIG. 1 is a schematic diagram of an instrument according the present invention.

### DESCRIPTION OF THE INVENTION

Spectrometers are widely used for the identification of substances in materials. An important measurement of performance in spectrometers is sensitivity, that is, the ability of the spectrometer to detect and/or measure substances that are present in only small amounts. The more sensitive the spectrometer, the smaller the amount of a sample that can be detected or measured. Another important aspect of performance of spectrometers is speed, that is, how long does it take for the spectrometer to complete the detection or measurement. One significant application of spectrometers is in the detection of improvised explosive devices (IEDs). Such spectrometers are preferably sensitive enough to detect the IED without being so close as to risk detonation and fast enough that they could be mounted on vehicles to detect an IED as the vehicle passes by it. Of course simplicity, reliability and durability are important for spectrometers that would be used in a war zone or other dangerous environment where IEDs can be expected to be present.

A LIBS Ocean Optics instrument makes use of seven separate fiber optics cable, seven collimating lenses, seven echelle gratings, seven focusing lenses, and seven CCD detectors. The multiplicity of elements adds to the cost and complexity of the instrument and results in a high loss of signal from the sample, decreasing the sensitivity of the spectrometer.

The InPhotonics instrument uses a single collection lens, aperture, collimating lens, echelle grating, order separator and focusing lens as the optics system. Light from the sample is directed by the optics system onto a 2-dimensional CCD detector. Both CCD and CID detectors require long reading times, slowing the responsiveness of the instrument. While the fastest CCD or CID detectors may take as little as 30 msec to read, the time delay may be as much as a full second.

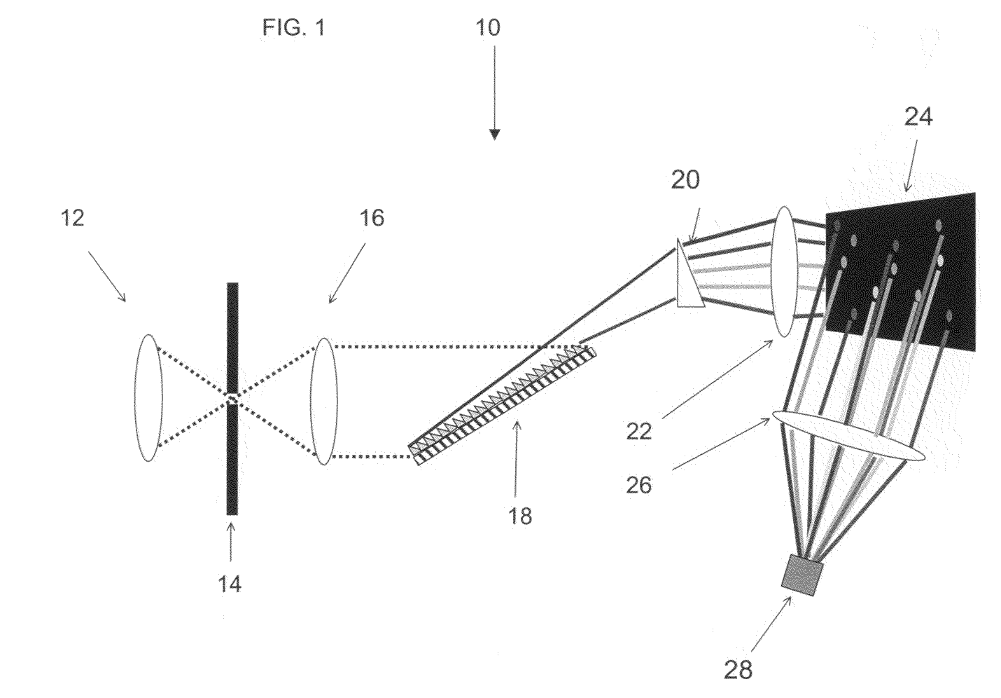

A schematic diagram of a preferred embodiment of the present invention, specifically a LIBS spectrometer, is illustrated in FIG. 1, generally at 10. Light from a sample to be analyzed passes through a collection lens that directs the beam through an aperture 14. The beam then passes through a collimating lens 16 and is directed onto an echelle grating 18 that disperses the beam into spectra. In the preferred embodiment the echelle grating is a model GE1325-3263 purchased from Thor Laboratories. The spectra may then pass through an optional prism 20 that acts as an order separator and then through a focusing lens 22 that focuses the spectra a microelectromechanical (MEM) digital micromirror device (DMD) array 24. The order separator prism 20 in the preferred embodiment is a model PS854 purchased from Thor Laboratories. Echelle gratings act as order separators such that the prism 20 may not be needed.

The MEMS DMD 24 has a large number of very small mirrors that are moved by semiconductor devices. MEMS DMDs are in common use in television sets where rapid switching of the diagonally hinged mirrors allows incident light to be modulated to form a quality video images for projection displays systems. In the preferred embodiment, the MEMS DMD 24 is a model 0.7 XGA DMD purchased from Texas Instruments. The spectra projected on the face of the MEMS DMD 24 form patterns that are characteristic of the substance or substances in the sample being analyzed. By adjusting the individual mirrors on the MEMS DMD 24 in a pattern that corresponds to the spectra of a substance of interest, light from the spectra of interest can be reflected through a focusing lens 26 and into a photodetector detector 28, which in the preferred embodiment is a single channel avalanche or PIN detector. In the present invention, control electronics are used to move the individual mirros on the MEMS DMD 24 to correspond to a selected substance of interest. Individual elements can be read by the instrument 10 to provide the same advantages as the CID-based instruments. Alternatively, a Hadamard transform may be used to obtain a complete spectrum of the light from the sample. The instrument 10 can provide a spectral analysis in between about 1 and about 10 nsec, some five orders of magnitude faster than the fastest CCD and CID detectors.

A particular application for the new spectrometer is in the detection of improvised explosive devices (IEDs) used by terrorists. The present instrument can be set to detect those specific, selected elements of the sample spectrum that are required to identify an IED and continuously monitor just those wavelengths. The instrument would be very rapid and provide a signal that would be at least a few orders of magnitude larger than that of the Ocean Optics system.

A second embodiment of the present invention is in spectrometers used in Raman spectroscopy. Commercial instruments use an echelle grating and a 2-dimensional CCD to obtain high-resolution Raman spectra with a small footprint. Replacement of the CCD detector with a the above-described MEMS DMD array 24 and detector 28 would provide similar advantages as in the LIBS spectrometer application, including the ability to monitor specific Raman bands without the time required to read-out the entire CCD chip.

The spectrometer 10 described can detect complete spectra using methods known as digital transforms. A digital transform, such as a Hadamard transform, is created in a digital computer associated with the control electronics of the instrument 10. The control electronics sends digital signals to the MEMS DMD 24 that positions the individual mirrors on and off in a known fashion. The spectrum can be recovered from the signals detected by the single detector by inversing the matrix sent to the device and multiplying by the signal matrix.

The spectrometer 10 also provides a signal enhancement method. Spectrometers of the present invention also provide advantages not provided by either CCD or CID detectors, including the ability for synchronous detection of multiple wavelengths. The excitation source can be modulated, for example by using a continuous wave laser, and the signal can be observed at the modulation frequency using a detector such as a lock-in amplifier. The advantage to this type of modulation would be removal of interferences. For example, detection in sunlight introduces large interferences due to the solar spectrum. This interference can be largely removed with detection at a high frequency and narrow bandwidth. The slow read out time for a CCD or CID does not permit this type of detection to be used.

The spectrometer design further provides a method to detect signals that are short pulses, on the order of 10 msec or less. Commonly, high-powered lasers produce pulses of light that are very short. In order to optimally detect these signals, a gated detection system is used to send only the signal in the short pulse time period to the detector. A typical form of this detection is called boxcar integration. The time required to read a CCD or CID does not permit this type of detection to be used for signals that are shorter than about 30 msec.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A spectrometer, comprising:
(a) optical elements for collecting light from a sample to be analyzed;
(b) a dispersion grating onto which light from the sample is directed by the optical elements and which disperses the light from the sample;
(c) a digital micromirror array positioned to receive dispersed sample light from the grating; and
(d) an optical detector positioned to receive sample light from the digital micromirror array.

2. A spectrometer as defined in claim 1, wherein the digital micromirror array is set to monitor only selected wavelengths of the sample light.

3. A spectrometer as defined in claim 1, wherein the dispersion grating is an echelle grating.

4. A spectrometer as defined in claim 1, further comprising an order separator between the grating and the micromirror array.

5. A spectrometer as defined in claim 1, wherein the micromirror array comprises a microelectromechanical digital micromirror device array.

6. An instrument for identifying explosive devices, comprising:
(a) a laser for vaporizing a sample of a suspected explosive device to generate a light signal;
(b) optical elements for collecting a portion of the light signal;
(c) a dispersion grating onto which the collected light signal is directed by the optical elements and which disperses the light signal;
(d) a digital micromirror array positioned to receive dispersed light from the grating and set to reflect only wavelengths specific to explosive devices to be identified;
(e) an optical detector positioned to receive sample light from the digital micromirror array; and
(f) means for generating an audible or visual alarm if wavelengths specific to an explosive devise to be identified have been detected.

7. A method for detecting complete spectra, comprising the steps of:
(a) projecting a spectrum onto a micromirroy array having a plurality of individual mirrors;
(b) sending digital signals to the micromirror array to turn on and off the individual mirrors following a selected digital transform signal matrix;
(c) detecting the spectrum reflected from the micromirror array in a detector; and
(d) recovering the complete spectrum from the detector by inversing the matrix sent to the micromirror array and multiplying by the signal matrix.

8. A method of enhancing the signal of a spectrometer, comprising the steps of:
(a) modulating an excitation source for generating a signal to be analyzed by the spectrometer;
(b) generating a spectrum from the signal;
(c) projecting the spectrum onto a micromirror array; and
(d) detecting the spectrum reflected from the micromirror array in a detector modulated in synchrony with the excitation source.

9. A method of spectroscopy, comprising the steps of:
(a) using an excitation pulse of duration less than 10 msec for generating a signal to be analyzed by spectroscopy;
(b) generating a spectrum from the signal;
(c) projecting the spectrum onto a micromirror array; and
(d) controlling the micromirror array to send the spectrum to a detector only during the duration of the pulse.
